(19) United States
(12) Patent Application Publication
(10) Pub. No.: US 2024/0112305 A1
(43) Pub. Date: Apr. 4, 2024

(54) REAL-TIME FIDUCIALS AND EVENT-DRIVEN GRAPHICS IN PANORAMIC VIDEO

(71) Applicant: COSM,INC., Dallas, TX (US)

(72) Inventors: Brian C. Lowry, Emlenton, PA (US); Evan A. Wimer, Butler, PA (US); Philippe D. Hall, McCandless, PA (US); David R. Fischer, Pittsburgh, PA (US)

(21) Appl. No.: 18/264,860

(22) PCT Filed: Feb. 10, 2022
(86) PCT No.: PCT/US2022/015989

§ 371 Date: Aug. 9, 2023

Related U.S. Application Data
(60) Provisional application No. 63/148,424, filed on Feb. 11, 2021.

(30) Foreign Application Priority Data
Feb. 11, 2021 (US) 63148424

(51) Int. Cl. G06T 5/50; G06T 11/20; G06T 15/00; G06V 10/25

(52) U.S. Cl. CPC G06T 5/50; G06T 11/203; G06T 15/00; G06V 10/25; G06T 2207/20221

(57) ABSTRACT

A method and system are described where graphics, for example, fiducials, are placed within the context of panoramic video footage such that those graphics convey meaningful and relevant information, such as first down lines, sidelines, end zone plane, three-point line, goal line, blue line, positional environmental, or biometric information. Graphics may also signify the status of event, such as whether a first down was made or whether a play was overturned. The system includes one or more cameras connected to a computer that also receives synchronized sensory data from one or more environmental or positional sensors. The fiducials may be based upon the content and context of the video, or augmented via the use of external sensors which may be aggregated by the computer, with graphics being generated and displayed on a frame-by-frame basis for the purposes of disseminating information and enhancing the live production.

### CROSS REFERENCE TO RELATED APPLICATION

This application is a PCT of U.S. Provisional Application Ser. No. 63/148,424, entitled “REAL-TIME FIDUCIALS AND EVENT-DRIVEN GRAPHICS IN PANORAMIC VIDEO”, filed on Feb. 11, 2021, which is incorporated by reference in its entirety.

### BACKGROUND

For over twenty years, sports enthusiasts have benefited from seeing the “1st and Ten” line in American football. The technology was originally developed independently by Sportsvision and PVI Virtual Media Services in the late 1990's, debuting in ESPN's® coverage of a Cincinnati Bengals-Baltimore Ravens game on Sep. 27, 1998. ESPN is a registered trademark of ESPN, Inc. in the United States and other countries

### BRIEF SUMMARY

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates a block diagram of the invention apparatus.

FIG. 2A illustrates principles involved in image capture.

FIG. 2B illustrates an example of FIG. 2A.

FIG. 3 illustrates a means for determining object locations in a football field.

FIG. 4 illustrates a video frame with a LTG fiducial.

FIG. 5 illustrates a non-contiguous succession of video frames with graphics generated in response to field-object sensors.

FIG. 6 illustrates a means for creating personalized immersive camera experiences from a plurality of game cameras, via the Internet.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Traditional systems use a calibrated 3D model of the sports field, in conjunction with multiple cameras, and computers for each of those cameras. At its heart, it relies on a video technique called chromakeying. This is the familiar “green screen” technique used in broadcast weather forecasts. In the studio, the background is an empty, mono-color canvas, while a computer composites or “pastes” the picture of the weather map over the colored background.

Using the chromakeying technique, placing graphics, for example, the first down line, on a live event image is more complicated to implement due to the center crown of the field which exists to drain water. Thus, a complex laser alignment system is employed for modelling the playing field geometry. This is done for each and every playing surface, albeit typically once per playing season. Additionally, due to the nature of chromakeying, difficulties occur when the player's uniforms contain green or are otherwise similar to the “screen”. Likewise, varying colors of grass or turf can cause problems. In instances where the player's uniforms contain colors similar to the turf, those sections of the uniforms will “disappear” during the chromakeying process.

Another limitation of this system is that it can only be done with pre-calibrated cameras. Other limitations involve the personnel requisite for implementation. Typically, in live event production, graphics are inserted towards the end of the production pipeline. All camera views are ingested into the production backhaul and displayed in the production center, where the producer calls out the camera(s) that is to go live. The cadre of production operators insert pre-designed graphics combined with real-time statistics and customized computer software to produce the final, televised video.

As the live events production industry reacts to industry changes requiring fewer personnel in the field, what is needed is a means by which production-level graphics can be used to augment the event coverage, thus increasing entertainment value. Moreover, lower-tier events, such as college and secondary school events which do not garner the production budgets of professional sports, can benefit from this invention.

As legalized betting gains momentum in conjunction with televised and streamed sports, what is needed in the industry are superior means for adjudicating plays, referee calls, and outcomes. By combining camera capture with the ability to augment with real-time fiducials, outcomes may be more quickly discerned.

More details regarding object tracking, data aggregation, generation of objects in panoramic video, and sharing experiences in panoramic video can be found in Applicant's previously issued U.S. Pat. No. 10,094,903 titled “Object tracking and Data Aggregation in Panoramic,” U.S. Pat. No. 9,588,215 titled “Object tracking and Data Aggregation in Panoramic Video,” U.S. Pat. No. 10,623,636 titled “Generating Objects in Real Time Panoramic Video,” and U.S. Pat. No. 10,638,029 titled “Shared Experiences in Panoramic Video.” The details contained in these patents is incorporated by reference herein, as if they were set forth in their entirety.

Bender et al. (U.S. Patent Application Publication No. 2014/0063260) discloses a pylon-centric replay system consisting of three high-definition cameras, facing in such angles so as to capture substantially a 180° wide angle view of the field, including side and goal lines.

Halsey et al. (Admiral LLC in U.S. Pat. No. 10,394,108 B2) discloses a corner-oriented pylon variant that reduces the camera density, but offers the same wide angle. This pylon's camera is connected to the broadcast backhaul via a video transmission cable—typically coaxial or fiber optic.

In July, 2019, Applicant, C360 Technologies, demonstrated, under the auspices of ESPN, an improved pylon that uses a single optic, single sensor solution that further reduced the pylon camera count while providing both wide angle view and superior video quality. Moreover, due to integral wireless transmission, the pylon could be moved readily around the field, and as such was suitable for use in the line to gain (LTG) marker. Coupled with this innovation is the ability to produce complex replay scenarios due to the fact that the camera is capturing and recording video from a substantially hemispherical field of view which captures the entire playing field, including sidelines, from the point of view of the camera. The invention disclosed herein purports to augment the state of the art with real-time, event-based fiducials and graphics.

For a better understanding of the embodiments, together with other and further features and advantages thereof, reference is made to the following description, taken in conjunction with the accompanying drawings.

The description now turns to the figures. The illustrated embodiments of the invention will be best understood by reference to the figures. The following description is intended only by way of example and simply illustrates certain selected exemplary embodiments of the invention as claimed herein.

It should be noted that the block diagrams in the figures illustrate the architecture, functionality, and operation of possible implementations of systems, apparatuses, methods and computer program products according to various embodiments of the invention. In this regard each block in the block diagram may represent a module, segment, or portion of code, which comprises at least one executable instruction for implementing the specific logical function(s). It should also be noted that, in some alternative implementations, the functions noted in the block diagram might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and combinations of blocks in the block diagram can be implemented by special purpose hardware-based systems that perform the specified functions or acts, or combinations of special purpose hardware and computer instructions.

While the example of a sporting event will be used here throughout to provide ease of understanding, it should be understood that the described system and method is not limited to simply providing graphic overlays onto sporting event images. Rather, the described system and method can be implemented in a variety of “live-image” feed situations, for example, news coverage, distance learning environments, medical environments, augmented or virtual reality environments, or the like. Thus, the description herein is not to be construed as limiting the described system to sporting events and it is easily understood from the description herein how the described system and method can be applied to other use cases, applications, or technologies.

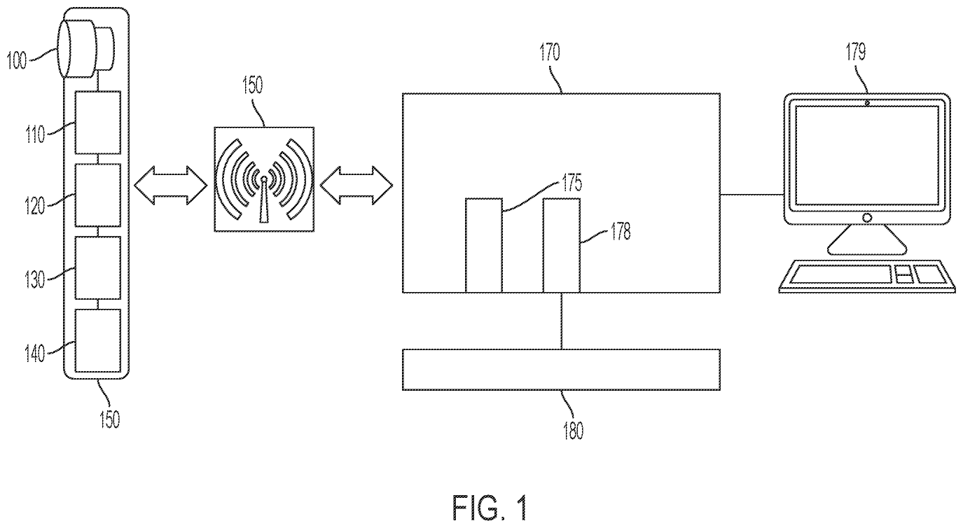

FIG. 1 depicts a block diagram of the devices and components in one embodiment of this invention. In this embodiment, a camera (100), sensors (110), embedded processor (120), transmission device (130) and battery (140) are co-located in a pylon (150). The pylon in this embodiment is a National Football League (NFL®) or National Collegiate Athletic Association (NCAA®) specified pylon, with dimensions of ˜18″ in height, ˜5″ in both width and depth for Line to Gain and ˜18″ in height, ˜4″ in both width and depth, for end zone and suitably constructed with foam and composite plastic materials such that it is lightweight injury to the players if it were to be struck in the course of game action. These pylons are used to mark the field of play, and are required to be located in both end-zone front and back corners, as well as the first down line. Whereas the end zone pylons are stationary, the first down line changes during the course of the game, and as such must not be encumbered by power or video transmission wires. NFL is a registered trademark of NFL Properties LLC in the United States and Other Countries. NCAA is a registered trademark of National Collegiate Athletic Association in the United States and other countries.

The camera (100) is a broadcast-quality camera with such attributes as to allow it to be aired live during the game as well as via replay. These attributes include large dynamic range (typically >64 dB), high resolution, global shutter, 10-bit 4:2:2 chroma subsampling, and nominally 60 frames per second (fps). In the example embodiment, the camera utilizes a “fisheye” lens with a field of view such that the sidelines are captured by the camera. This is essential to capture plays for the purpose of adjudicating referee calls, e.g., whether a player's foot was in or out of bounds, etc. Thus, the horizontal field of view is nominally 180°. An example lens may be a dioptric 4 mm f/2.8 lens which gives the camera a 210° horizontal field of view.

In one embodiment, a sensor array (110) may be utilized. The purposes of the sensor(s) is to inform the embedded processor (120) of the orientation and position of the pylon as it relates to the playing field. In this embodiment, an embedded processor (120) aggregates information from the positional sensors (110) and synchronizes this information with the video stream.

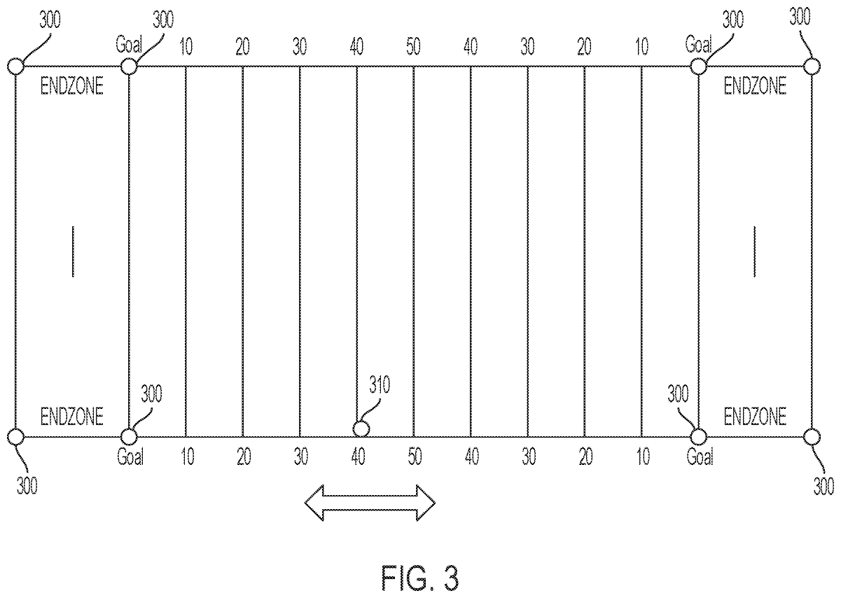

FIG. 3 shows a schematic of an American football field. Using Real Time Location Services (RTLS) technology we can accurately determine the location of the pylon as it traverses the field of play. Stationary anchor transducers (300) are located in the corners of the field, either in the pylons, or beneath the turf In one embodiment, the anchors may be Ultra-Wide Band (UWB) transceivers. These battery-powered units communicate in the 6.5 GHz channel with a sensor (110) which is located in the pylon (310/150). This pylon sensor is capable of producing multiple information streams, including sensing motion, relaying pylon position relative to the anchors (300) with accuracy to within 10 cm, as well as pylon orientation via an on-board 3-axis accelerometer. This information is ingested by the embedded processor (120) at 10's to 100's of Hz, with higher frequencies negatively impacting battery (140) life for the benefit of faster response times. UWB is a well-established means for RTLS, and is an IEEE standard (15.4-2011). Moreover, it operates over ranges useful and necessary for field sports (300 m). It should be noted that regardless of the sensor type, it may be polled at frequencies different from the video capture frequency. For example, a UWB position may be updated at 10 Hz, while the camera captures at 60 Hz. This will be reflected in the metadata synchronized with each vide frame.

Returning to FIG. 1, in one embodiment, the embedded processor may be a System on a Chip (SoC) design that combines a multi-core CPU, Graphics Processing Unit (GPU), unified system memory with multiple standard I/O interfaces, including i2c, USB, Ethernet, GPIO, and PCIe. These small, ruggedized units are designed to withstand the environmental extremes found in out-of-doors events. Furthermore, they are cable of encoding multiple 4k (4×HD resolution) 60 fps streams concurrently with very low latency (<100 ms). Other embodiments may include other chip designs, processing units, and/or the like.

Other potential sensors (110) may include, but are not limited to, proximity sensors, environmental sensors (temperature, humidity, moisture), and Time of Flight (ToF) sensors, which may be used to accurately determine the distance of objects from the sensor. Additionally, audio microphones may be used to capture sounds in the vicinity of the pylon. Later in this description, we will provide examples in which these sensors can be used to augment the live broadcast and replay.

The pylon (150) also contains a radio transceiver (130) which is used to wirelessly communicate (160) the video and sensor stream to a production workstation (170). Any radio technology capable of supporting sustained average (constant or adaptive) bitrates greater than 20 Mb/s is viable. These technologies may include “WiFi” (802.11 variants), cellular transmission via 4G LTE, 5G, or the like. A battery (140) provides power for the camera, sensor array, embedded processor, and radio transceiver. Ideally, the battery will last the course of the game, but this is not specifically required.

Typically, the production workstation (170) is located in an Outside Broadcast (OB) truck in a media complex adjacent to, or in the vicinity of, the sporting event, although remote (REMI) productions are becoming more commonplace. Due to the high frame rate and high resolution video processing, much of the computational effort is accomplished on the workstation's GPU (175). Different GPUs may be utilized in the described system. The nature of these computations will be discussed below.

The workstation (170) may be controlled by a human operator via mouse, keyboard, monitor, or bespoke controller device optimized for quickly framing replays. During the course of a live event, the producer may elect to “go live” with the transmitted pylon camera feed. Alternatively, the operator may produce replay segments which are a succession of video frames highlighting a particular play or event. Replayed video segments are often played at a slower frame rate, allowing the viewers to discern more detail in the replayed event. Whether “live” or via replay, video frames processed via the workstation are pushed to the backhaul (180) where they may be used for the production. The broadcast industry has adopted numerous SMPTE (The Society of Motion Picture and Television Engineers) standards such as the Serial Digital Interface (SDI) which specifies an uncompressed, unencrypted audio/video data stream. A PCIe interface card (178) is used to convert each successive video frame, in GPU (175) memory, into its respective SDI video frame.

Having discussed the major components in the present embodiment, let us turn our attention to the workflow and resultant outcomes.

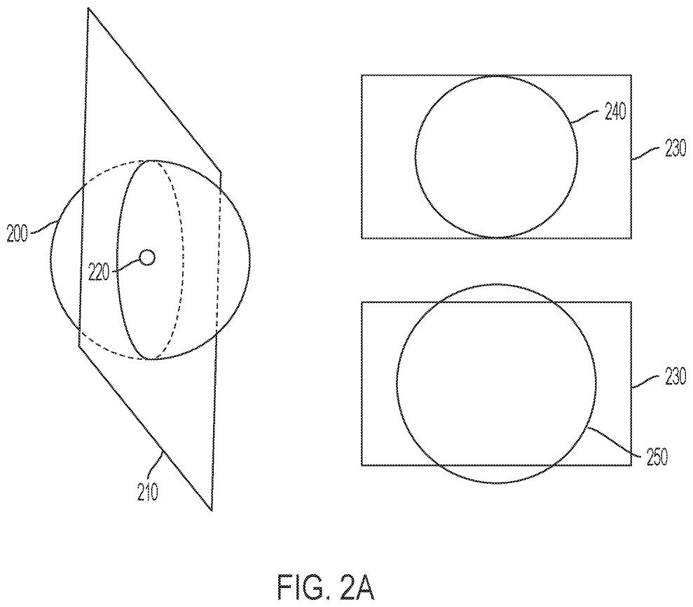

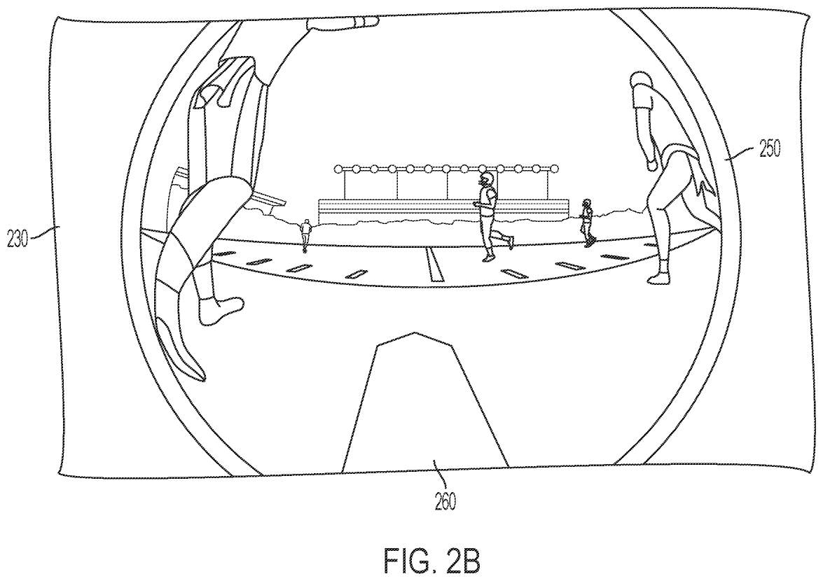

FIG. 2A is instructive in helping to understand concepts involved in capturing panoramic video. A sphere (200) is bisected by a plane (210). Let us imagine an observer (220) located at the center (origin) of the sphere. In the present embodiment, the camera is located at the observer's position, with the optic axis orthogonal to the bisecting plane. Thus, a 180° (altitude)×360° (azimuth) field of view (FOV) is captured by the camera. In the current embodiment, a lens is used, as was noted, that permits an even greater FOV, such that we capture a 210°×360° FOV.

The camera contains an imaging sensor, typically a Complementary Metal Oxide Semiconductor (CMOS) device that converts incident light, directed by the camera optics (lens) into electrical potentials. This technology is the heart of most modern digital imaging devices. FIG. 2A describes two scenarios for capturing panoramas. The CMOS sensor (230) is typically 16:9—the aspect ratio of broadcast as well as “smart” TVs and monitors. There are, however, sensors that are 4:3 aspect ratio, and even square (1:1) aspect ratio. The CMOS contains an array of regular pixels arranged in rows and columns, the product of which is called the sensor resolution. A High Definition (HD) video sensor has 1080 (vertical)×1920 (horizontal) pixels, resulting in a resolution of ˜2 million pixels (2MP). One embodiment utilizes a 4k sensor with 3840×2160 pixels.

Most lenses are radially symmetric, and thus produce image circles, whether complete or truncated, on the sensor plane. If the image circle (240) formed by the optics falls completely within the sensor area, then the entire FOV will be captured. If, however, the optics create an image circle that exceeds the sensor's area (250), the FOV in one direction will be truncated. In the present embodiment, the camera is positioned such that the horizontal FOV aligns with left/right on the playing field so as to capture the widest FOV (i.e., capturing the sidelines). Up/down is aligned with the vertical dimension of the sensor. Clearly, one can see that areas outside the image circle (240, 250) are essentially wasted in that they contain no information from the scene. Ideally, the system attempts to maximize the number of active pixels recruited, even at the expense of loss of vertical FOV. Naturally, an anamorphic lens may be employed which is not radially symmetric. In this case, the image circle is transformed into an image ellipse which can better recruit the sensor pixels.

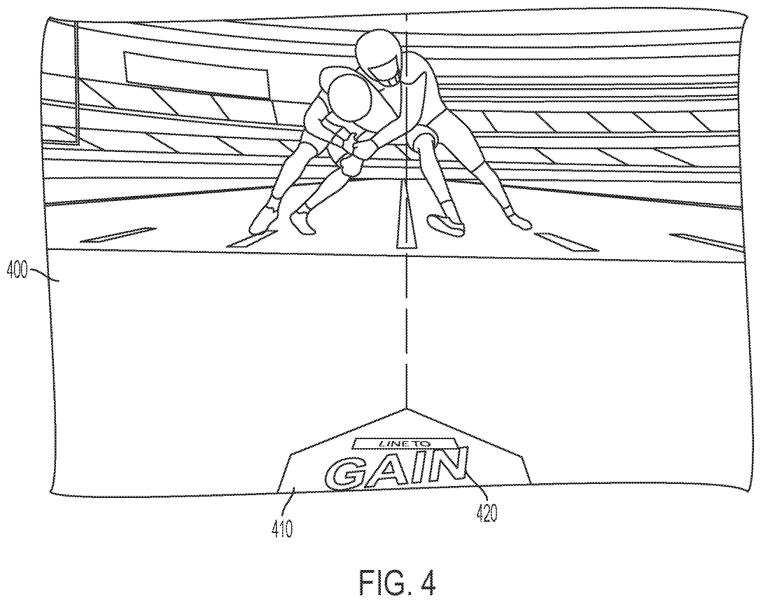

Using the illustration of FIG. 4, the method and process of capturing wide FOV video images and augmenting with real-time fiducials is described. For ease of understanding, a singular video frame (400) is shown. However, it should be understood that the described method is applied to many video frames. The illustrated video frame is an HD (1920×1080) resolution “still” from a video sequence showing a near sideline play. The camera and lens (100) capture substantially a hemisphere of information (230/240) at a frame rate of 60 Hz with a significantly higher resolution of 3840×2160. These frames are sequentially encoded by an embedded processor (120). Synchronously captured sensor (110) information is stored as metadata with each video frame, and then pushed to the wireless transmitter (130) for relay to the operator/production workstation (170) where it is ingested. The bit rate at which the signal is transferred directly correlates with the quality of the received signal. In a non-limiting embodiment, the HEVC (H.265) codec, which can provide lossy 1000:1 compression, is employed. Other codecs, including inter-frame, or mezzanine compression codecs such SMPTE RDD35, providing lower compression ratios of 4:1, may be employed. Practically, the choice of codec is determined by the available transmission bandwidth, as well as the encoding/decoding latency, and power, and resolution requirements. Once the encoded video is received and buffered, it is then decoded. This may be performed on the GPU (175) due to its integral hardware decoder, or it may be performed on an external bespoke decoding appliance. In the preferred case of GPU decoding, once each video frame is decoded, it is immediately available in GPU memory for subsequent video pipeline processing.

It should be noted that for simplifying the description of this invention, several of the video pipeline stages have been omitted for clarity, including, flat-field correction, color corrections, image sharpening, dark-field subtraction, and the like.

At this point, the system has created and stored a decoded video frame, along with its concomitant sensor-rich metadata, in GPU memory. When drawing fiducials or other graphics that are to appear in the production video, the system employs a 3D spherical (200) model as is shown in FIG. 2A. Prior to outputting video frames to the backhaul (180), however, the video frames are typically converted from the spherical model space into a rectilinear space suitable for 2D viewing. FIG. 2B illustrates an exemplary captured video frame using the image capture principles illustrated in FIG. 2A. FIG. 2B shows the sensor area (230), as well as the image circle section on the sensor. As described earlier, the example shown in FIG. 2B has a 210° horizontal FOV, whereas the vertical FOV is truncated due to the fact that the image circle is not completely formed on the sensor. In comparing the video frame in FIG. 2B to that in FIG. 4, it can be seen that the image in FIG. 2B is distorted. Due to the extreme wide angles captured with the short focal length “fisheye” lens, the individual video frames must undergo a rectification process, also known as “de-warping. This results in video frames with the correct, and natural, perspective. Each lens must be calibrated so as to characterize the fisheye distortion function.

The proposed family of augmented reality graphics leverages the fact that the camera is capturing partial 3D video. The video is partial 3D in the sense that only directional component is present with no native depth information, although some depth information can often be inferred. For example, we know a priori the approximate height of a football player, so we are able to infer the distance from the camera. Assuming the physical camera is stationary and the feed is viewed on a non-stereoscopic display, as is typical, then convincing 2-D or 3D graphics can be placed almost anywhere in the scene with little to no additional hardware, providing a resulting image that appears much like an image utilizing a traditional chromakeying system. However, it should be noted that the described system and method provides images benefits that are not found in the traditional chromakeying system, for example, more accurate fiducials and/or graphic placement, minimization of image effects caused by similarities between the color of the “screen” used in chromakeying and objects within the image, and the like.

The degree of difficulty of such graphic placements depends on which actual scene entities the graphic is desired to appear between. For example, graphics that are meant to appear directly between the camera and the scene such as the Line to Gain marker, telestrations, or heads-up-display style objects can be placed trivially. However, graphics that are intended to appear realistically between dynamic entities such as players and static entities, for example, the stands, field/court, or the like, can be placed with an accurate but potentially simple model of the static entities and chromakey-like techniques. As the 3D video already exists on the system described, the graphics can be rendered into the scene in real time on the hardware described in conjunction with the Figures. Placing graphics between dynamic entities, such that portions of the graphics are occluded, may require a full 3D (multiple camera) capture.

Returning to the 3D model concept, the camera feed is a stretched (warped) onto a first sphere. In computer memory, a secondary sphere is created for the purposes of drawing graphics. Using techniques of 3D computer modeling involving texture and fragment shaders, fiducials can be introduced, via graphic primitive call, into the second sphere. At the end of the processing for each frame, the two spheres will be merged or fused, and finally, a 2D video region of interest will be excerpted from the model.

In FIG. 2B, the physical LTG marker (260) is shown. This is an orange fabric marker that is placed by the referees. In FIG. 4, the LTG marker (410) is a digitally augmented fiducial created in the computer model. Control software allows the system to vary the width and length of any overlaid graphics, for example, fidicucials, such that it “overlays” the physical LTG on the field. Opacity controls further aid in the adjustment such that the augmented fiducial appears accurately. The digitally augmented LTG marker has the additional benefit of providing useful “real-estate” for the purposes of introducing information, for example, referring to FIG. 4, text (420) reading “LINE TO GAIN” has been illustrated. However, other information may be displayed, or the area could be used for sponsorships, advertisements, or the like.

Unlike the physical LTG marker, which exists only on the sidelines as permitted by the league, the digital fiducial can extend in space as shown by the “vertical” line emanating from the point on the marker and continuing upwards through the vertical FOV. Thus, this line is a longitudinal line drawn on the second sphere, initially centered on the plane of the optic axis. Digitally extending the physical fiducial makes it all the more useful in adjudicating referee calls, since it provides a unique visual in spatially and temporally discerning ball, hands, and foot associations as the play transpires.

In one embodiment of the invention, the control of the LTG fiducial is actively provided to the computer (170) operator. This is done on a play-by-play basis. For example, if the physical LTG pylon were not oriented perfectly—whether rotated or tilted backwards/forwards—then the operator would be able to adjust the rotation (yaw) and tilt (pitch) via controls provided in the software for changing those angles of the second sphere on which the graphics are drawn.

In a second embodiment of the invention, active, automatic control of the fiducial is accomplished by using the information from the sensor array (110). In a non-limiting example, the 3-axis accelerometer data from the pylon (100) can determine the orientation of the pylon with respect to the playing field. Using this information, the second sphere can be rotated along its three degrees of freedom to compensate. Thus, as the pylon is moved and repositioned, the software will continuously adjust the fiducial, via a feedback loop, much like a bubble level or gyroscope.

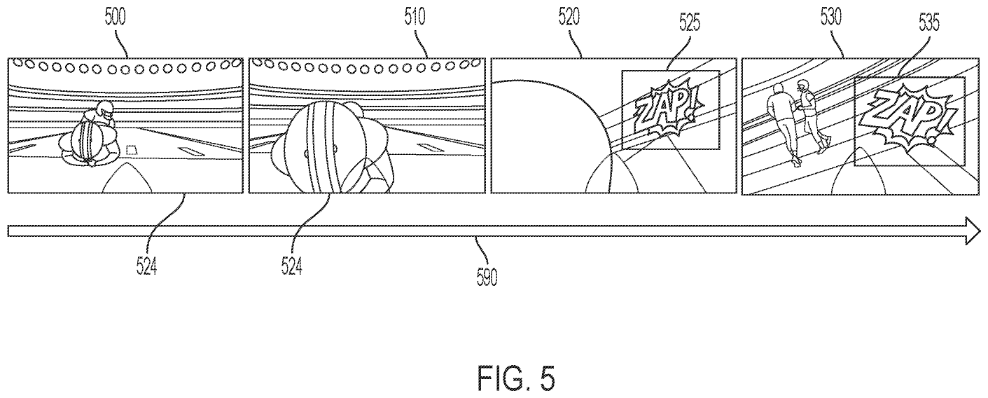

Additionally, the sensor (110) information can be used to enhance the broadcast in other interesting manners. It is common during the course of play for the pylons to be translated from their proper orientation, typically by a collision from one or more players. Such a scenario is shown in FIG. 5. This figure shows a succession of non-contiguous video frames (500, 510, 520, 530) leading to a player colliding with the pylon. The progression of time (590) is shown moving from left to right. Since frames are being acquired at 60 Hz, most of the video sequence is not shown, but it should be understood that the graphics that are injected on a frame-by-frame basis, such that animations may be achieved. In frame 500 the player with the ball is approaching the pylon head-on, in frame 510 the player is about 14″ away from the pylon, frame 520 shows imminent contact, and frame 530 shows the pylon displaced by the collision. Using the sensor array (110), the proximity of the player can be determined by an inexpensive ultrasonic detector coupled to the embedded system (120). At that instance, a graphic highlighted in 525 may be shown, which enlarges and translates (535) as the collision occurs. An accelerometer may be used as well to determine the positional translation during the collision, or to even compute the forces involved.

This is merely one non-limiting embodiment that demonstrates the vast potential for augmenting the live events with autonomous graphic insertion. It should be noted that the graphic may be pre-designed, such as a PNG or JPEG graphic, or it may be composed in real time. Video frames of 60 Hz allow for computer operations to be performed that can be completed in <16.67 ms—the inter frame interval. Modern GPUs are capable of thousands of operations per millisecond. More than one graphic may be inserted, as well as changes to video rendering itself, such as composited views shown as a picture-in-picture. This would be feasible if the camera captured not only the collision, or some other notable play, as well as side-line action from others players or the coaching staff.

In a second non-limiting embodiment, the distance between a player and the pylon camera may be written graphically on the successive video frames as is shown by 524. Once can see that as the player approaches the pylon, which is stationary during the course of each play, the distance decreases. As discussed above, the proximity-sensing information may come from either proximity sensor (110) embedded in the pylon (150) or via external tracking information as is taught in applicant's previous patent(s)—Object tracking and Data Aggregation in Panoramic Video. In this embodiment, each player or object on the field of play (e.g. ball) is equipped with one or more tracking devices, such that their position relative to each other and the playing field is captured in real-time as a serialization of Euclidean coordinates. Typically, this data, in the form of a UDP “blast” or stream, is ingested at the operator workstation (170) via a TCP/IP connection from the purveyor's server. This data is frame-synchronized with each of the broadcast cameras, including the pylon cameras. In this way, real-time continuous measurements may be made between any or all of the pylons and any or all of the tracked objects.

Other non-limiting embodiments include thumbs up/thumbs down for overturning plays, inserting advertisements, such as “this collision brought to you by Brand Name”, or the like. Augmentation is not limited to graphics, but may also include audio. Typically, audio production occurs synchronously yet independently from the camera production. This is to allow for commentators, and the like, to discuss the game, while local point of view cameras contribute to a distinct field effects audio channel(s) that is intermixed with the commentator contribution channel(s). Thus, in one embodiment, audio “bites” may be triggered by action on the field, sensor input, or by the operator.

As discussed, the model consists of two 3D spheres—one containing the video textures and the second being used for real-time graphics. On a frame-by-frame basis, these two models are “fused” with the video textures being drawn first, at a lower Z-level, and the secondary sphere graphics being drawn over the first, at a higher Z-level. As discussed above, a 2D rectified (de-warped) region of interest is excerpted from this model, then converted to a broadcast (SDI) frame for injection into the backhaul (180). This region of interest is determined both by the operator, or called for by the producer, in response to game action. The software allows for arbitrary pan, tilt, and digital zoom within the 3D composite model space, any of which may be excerpted in real-time or via replay, for push to the backhaul (180) as is taught in the author's previous patents. It may be, for the purposes of officiating, that certain “lockdown” views are employed. For example, two virtual camera views—one looking up the sideline, and the other looking oppositely down the sideline—may be created. In the current embodiment, the software is capable of four virtual cameras (VCAMs) that may or may not be physically output via SDI to the backhaul (180).

Referring again to FIG. 1, the workstation (170) GPU (175) is capable of Artificial Intelligence (AI) inferences. For example, a Deep Neural Network (DNN) may be trained, by ingesting numerous events, to make inferences about what is expected to transpire during a play. In this way, an AI software agent may be used to replace a physical person or persons tasked with creating replay video clips. These inferences may be made based upon both the video frames (and their content), as well as input from the sensor array. Thus, in one embodiment, a plurality of AI agents build the replay clips with no input or interaction from a human operator.

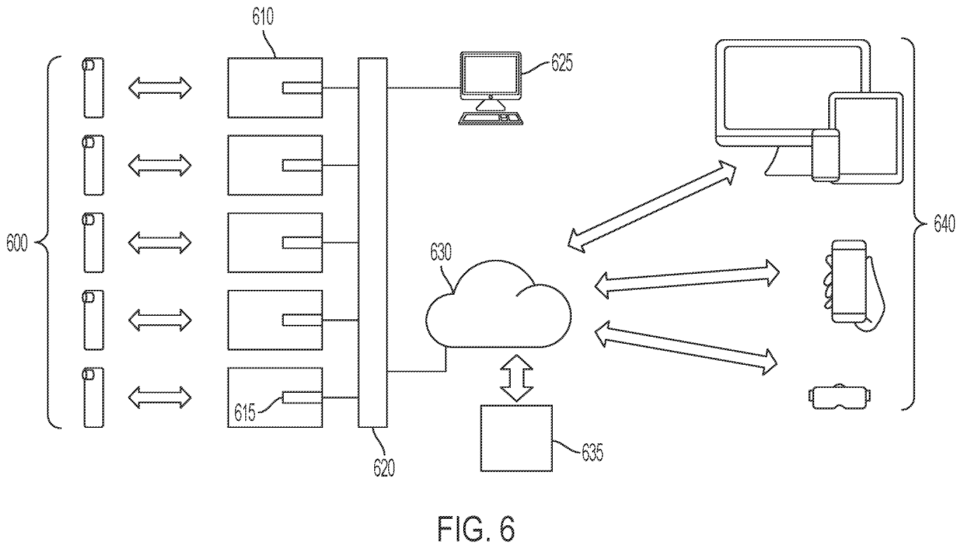

In addition to pushing content to the linear backhaul (180), the video may be streamed for OTT (Over the Top) consumption via a web-based video player, app, or “smart” TV. Referring to FIG. 6, we provide a non-limiting embodiment of the components involved. It should be understood that many details are omitted in order to provide clarity in describing the invention claimed in this disclosure. The plurality of cameras is shown (600), connected to workstations (610), each equipped with a Network Interface Card (NIC), which is in turn connected to a router (620), through which the internet (630) is accessed. A single operator console (625) may be used to access one or each of the workstations (610) through a KVM (Keyboard View Mouse) switch. While the workstations are providing replay and live video (SDI) feeds to the backhaul, they may simultaneously provide streaming experiences to many individual “smart” devices (640) connected to the internet. These devices included “smart” TVs, computers, tablets, phones, Virtual Reality (VR) googles, and the like. Unlike the broadcast, where a region of the immersive sphere is de-warped and output in 16:9 aspect ratio in a standard video format such as HD (1920×1080 pixels), the streamed experience contains the entire immersive hemisphere. In this way, each end user may choose their own Pan, Tilt, and Zoom (PTZ) within the context of an immersive player application that runs or is executed on their device.

Typically, a single origin stream is relayed to a Content Distribution Network (CDN) (635) that facilitates the transcoding and distribution of the stream to many users. The end user's application receives an encoded stream from the CDN (635) in a format and bitrate that may differ from the original stream. The stream is then decoded, and the video frames are de-warped using the same algorithm as is used in the broadcast, and then displayed using calls to a graphics API, typically being accelerated by the device's GPU. The user is then free to interact with the immersive video in the same way that a broadcast or replay operator interacts with the pylon camera view. In this manner, the experience of watching a game is personalized. The application may be able to switch from one stream to another, which would allow the user to switch, for example, from camera to camera. The personalization of the OTT immersive experience may also extend to the nature and type of graphics that are inserted into the player application. As with the broadcast video, the OTT stream carries with it, via metadata, the state of all attached sensors, as well as, relevant tracking information, as is taught in applicant's previous patents. In this way, the viewing application may be highly customized for each individual's preference regarding the type of graphics, colors, statistics, notifications, etc. that are displayed.

The present embodiment describes a use case for an American football pylon. Other embodiments include use in hockey and soccer nets, showing fiducials for whether the puck or ball crosses the plane of the goal.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
obtaining, using at least one image capture device, at least one panoramic image;
receiving an indication to add a real-time graphic to the at least one panoramic image before transmission of the image to an end user;
generating a first sphere from the at least one panoramic image;
generating a second sphere, wherein the generating a second sphere comprises adding the real-time graphic into the second sphere;
generating a single model by fusing the first sphere with the second sphere having the real-time graphic; and
generating a broadcast frame from the single model by excerpting a region of interest from the single model and converting the region of interest to the broadcast frame.

2. The method of claim 1, wherein the obtaining comprises obtaining metadata with the at least one panoramic image.

3. The method of claim 1, wherein the obtaining comprises obtaining a plurality of panoramic images and generating, from the plurality of panoramic image, a full three-dimensional image.

4. The method of claim 3, wherein the placing the real-time graphic comprises placing the real-time graphic between dynamic entities within the full three-dimensional image.

5. The method of claim 1, wherein the adding the real-time graphic comprises a user adjusting at least one characteristic the real-time graphic before placement within the second sphere.

6. The method of claim 1, wherein the adding the real-time graphic comprises automatically, using software, placing the real-time graphic within the second sphere and wherein the placing comprises automatically, using the software, adjusting at least one characteristic of the real-time graphic.

7. The method of claim 1, wherein the fusing comprises drawing graphics of the second sphere over the first sphere.

8. The method of claim 1, wherein the real-time graphic is derived from information captured by one or more sensors.

9. The method of claim 1, wherein excerpted region of interest comprises a two-dimensional rectified region of interest.

10. The method of claim 1, further comprising transmitting the broadcast frame to a user.

11. A system, comprising:
at least one image capture device;
a processor operatively coupled to the at least one image capture device;
a memory device that stores instructions that, when executed by the processor, cause the information handling device to:
obtain, using the at least one image capture device, at least one panoramic image;
receive an indication to add a real-time graphic to the at least one panoramic image before transmission of the image to an end user;
generate a first sphere from the at least one panoramic image;
generate a second sphere, wherein the generating a second sphere comprises adding the real-time graphic into the second sphere;
generate a single model by fusing the first sphere with the second sphere having the real-time graphic; and
generate a broadcast frame from the single model by excerpting a region of interest from the single model and converting the region of interest to the broadcast frame.

12. The system of claim 11, wherein the obtaining comprises obtaining metadata with the at least one panoramic image.

13. The system of claim 11, wherein the obtaining comprises obtaining a plurality of panoramic images and generating, from the plurality of panoramic image, a full three-dimensional image.

14. The system of claim 13, wherein the placing the real-time graphic comprises placing the real-time graphic between dynamic entities within the full three-dimensional image.

15. The system of claim 11, wherein the adding the real-time graphic comprises a user adjusting at least one characteristic the real-time graphic before placement within the second sphere.

16. The system of claim 11, wherein the adding the real-time graphic comprises automatically, using software, placing the real-time graphic within the second sphere and wherein the placing comprises automatically, using the software, adjusting at least one characteristic of the real-time graphic.

17. The system of claim 11, wherein the fusing comprises drawing graphics of the second sphere over the first sphere.

18. The system of claim 11, wherein the real-time graphic is derived from information captured by one or more sensors.

19. The system of claim 11, further comprising transmitting the broadcast frame to a user.

20. A product, comprising:
a computer-readable storage device that stores executable code that, when executed by a processor, causes the product to:
obtain, using at least one image capture device, at least one panoramic image;
receive an indication to add a real-time graphic to the at least one panoramic image before transmission of the image to an end user;
generate a first sphere from the at least one panoramic image;
generate a second sphere, wherein the generating a second sphere comprises adding the real-time graphic into the second sphere;
generate a single model by fusing the first sphere with the second sphere having the real-time graphic; and
generate a broadcast frame from the single model by excerpting a region of interest from the single model and converting the region of interest to the broadcast frame.
